(19) United States
(12) Patent Application Publication
(10) Pub. No.: US 2008/0188282 A1
(43) Pub. Date: Aug. 7, 2008

(54) SLOT MACHINE INCLUDING A PLURALITY OF SLOT GAME AREAS AND CONTROLLING METHOD THEREOF

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp.

(21) Appl. No.: 12/017,549

(22) Filed: Jan. 22, 2008

(30) Foreign Application Priority Data
Jan. 23, 2007 (JP) JP2007-012985

(51) Int. Cl. A63F 13/00

(52) U.S. Cl. 463/20

(57) ABSTRACT

A slot machine includes a plurality of slot game areas in each of which a slot game can be individually played and allows two or more slot games to be simultaneously played in one play session by betting medals on the two or more slot games in the respective slot game areas. In the slot machine, a slot game is executed in each of activated ones of the slot game areas on a liquid crystal display. Thereafter, in the activated slot game areas, the symbol matrices in each of which at least one combination of symbols leading to a payout is established are cumulatively displayed on an upper display. When the number of the symbol matrices finally reaches an upper limit, a special effect image is displayed.

### CROSS REFERENCE TO RELATED APPLICATIONS

This application is based upon and claims the benefit of priority from the prior Japanese Patent Application No. 2007-012985, filed on Jan. 23, 2007, the entire contents of which are incorporated herein by reference.

### BACKGROUND OF THE INVENTION

1. Field of the Invention

The present invention relates to a slot machine and a method for controlling the slot machine.

2. Description of the Related Art

In a relevant slot machine, when a player operates a start button after inserting a predetermined number of medals from a medal insertion slot, a plurality of (for example, 3) reels on each of which a plurality of symbols are drawn are individually rotated. Then, the reels are stopped after a predetermined period of time. In this event, when symbols that form a winning combination are stopped on a preset payline or when a predetermined number of scatter symbols are stopped, a payout corresponding to the number of inserted medals is provided.

Meanwhile, the following is disclosed in U.S. Pat. No. 6,855,052. Specifically, in the case where symbols displayed on reels when the reels are stopped form a preset combination, a plurality of wheels provided above the reels sequentially start spinning and are subsequently stopped. Thereafter, when the outcome of a stop of a wheel satisfies a predetermined stop position, a large number of medals are paid out.

### SUMMARY OF THE INVENTION

The present invention was made to solve the conventional problems described above. It is an object of the present invention to provide a slot machine having new entertainment properties and a method for controlling the slot machine.

A first aspect of the present invention is a slot machine comprising: a first display adapted to display a plurality of symbol matrices including a plurality of symbols arranged in the symbol matrices; a second display adapted to display a symbol matrix selected from the plurality of symbol matrices; and a controller configured to display a slot game on the first display, the slot game in which whether a credit is to be paid out or not is determined according to an arrangement determined by rearranging the plurality of symbols arranged in the symbol matrix, and cumulatively display on the second display the symbol matrices each having an arrangement of the symbols for which a payout of a credit is determined as a result of the slot games executed in the respective symbol matrices displayed on the first display.

According to the first aspect of the present invention, a slot game is designed to determine whether or not to pay out a credit based on an arrangement of a plurality of symbols determined by rearranging the symbols arranged in a symbol matrix. In addition, a slot game is executed in each of the plurality of symbol matrices displayed on a first display, while the second display cumulatively displays the symbol matrices, each having an arrangement of symbols for which a payout of credits is determined, as a result of the slot games executed in the respective symbol matrices displayed on the first display.

Accordingly, the second display cumulatively displays the symbol matrices, in each of which a payout of credits is determined, as a result of the slot games executed in the respective symbol matrices displayed on the first display. Thus, it is possible to provide new entertainment properties that allow a player to have expectations for cumulative display of the symbol matrices on the second display. The above configuration is also very effective in enhancing the player's motivation to play the game.

A second aspect of the present invention is a slot machine comprising: a first display adapted to display a plurality of symbol matrices including a plurality of symbols arranged in the symbol matrices; a second display adapted to display a symbol matrix selected from the plurality of symbol matrices; and a controller configured to display a slot game on the first display, the slot game in which whether a credit is to be paid out or not is determined according to an arrangement determined by rearranging the plurality of symbols arranged in the symbol matrix, cumulatively display on the second display the symbol matrices each having an arrangement of the symbols for which a payout of a credit is determined as a result of the slot games executed in the respective symbol matrices displayed on the first display, and highlight the symbol matrices displayed on the second display more distinctly with an increase of a number of the symbol matrices displayed on the second display.

According to the second aspect of the present invention, the slot game designed to determine whether or not to pay out a credit based on an arrangement of a plurality of symbols determined by rearranging the symbols arranged in the symbol matrix. In addition, a slot game is executed in each of the plurality of symbol matrices displayed on the first display, while the second display cumulatively displays the symbol matrices, each having an arrangement of symbols for which a payout of credits is determined, as a result of the slot games executed in the respective symbol matrices displayed on the first display. Moreover, the symbol matrices displayed on the second display are highlighted more distinctly as the number of the symbol matrices displayed on the second display is increased.

Accordingly, it is possible to allow the player to have higher expectations for cumulative display of the symbol matrices on the second display.

A third aspect of the present invention is a slot machine comprising: a first display adapted to display a plurality of symbol matrices including a plurality of symbols arranged in the symbol matrices; a second display adapted to display a symbol matrix selected from the plurality of symbol matrices; and a controller configured to display a slot game on the first display, the slot game in which whether a credit is to be paid out or not is determined according to an arrangement determined by rearranging the plurality of symbols arranged in the symbol matrix, cumulatively display on the second display the symbol matrices each having an arrangement of the symbols for which a payout of a credit is determined as a result of the slot games executed in the respective symbol matrices displayed on the first display, highlight the symbol matrices displayed on the second display more distinctly with an increase of a number of the symbol matrices displayed on the second display, and display a special effect image when the number of the symbol matrices displayed on the second display reaches a predetermined number.

According to the third aspect of the invention, the slot game designed to determine whether or not to pay out a credit based on an arrangement of the plurality of symbols determined by rearranging the symbols arranged in the symbol matrix. In addition, a slot game is executed in each of the plurality of symbol matrices displayed on the first display, while the second display cumulatively displays the symbol matrices, each having an arrangement of symbols for which a payout of credits is determined, as a result of the slot games executed in the respective symbol matrices displayed on the first display. Moreover, the symbol matrices displayed on the second display are highlighted more distinctly with an increase of the number of the symbol matrices displayed on the second display. Subsequently, a special effect image is displayed when the number of the symbol matrices displayed on the second display reaches a predetermined number.

Accordingly, it is possible to allow the player to have higher expectations for cumulative display of the symbol matrices on the second display and to make a significant impact on the player when a predetermined number of symbol matrices are accumulated on the second display.

The controller may be configured to reset the symbol matrices cumulatively displayed on the second display when all the slot games executable in the plurality of symbol matrices displayed on the first display are finished.

According to the above configuration, when all the slot games executable in the plurality of symbol matrices displayed on the first display are finished, the symbol matrices cumulatively displayed on the second display are reset.

Therefore, it is possible to provide new entertainment properties that allow the player to have expectations for whether the symbol matrices are cumulatively displayed on the second display before all the slot games executable in the plurality of symbol matrices displayed on the first display are finished.

The controller may be configured to reset the symbol matrices cumulatively displayed on the second display when a number of the symbol matrices cumulatively displayed on the second display reaches a predetermined maximum value.

According to the above configuration, when the number of the symbol matrices cumulatively displayed on the second display reaches a maximum value, the symbol matrices cumulatively displayed on the second display are reset.

Therefore, even if all the slot games executable in the plurality of symbol matrices displayed on the first display are finished, symbol matrices can be cumulatively displayed on the second display in the next game session. Thus, it is possible to provide new entertainment properties that allow the player to have expectations for cumulative display of the symbol matrices on the second display.

A fourth aspect of the present invention is a method for controlling a slot machine, comprising the steps of: executing a slot game, in each of a plurality of symbol matrices displayed on a first display, the slot game in which whether a credit is to be paid out or not is determined according to an arrangement determined by rearranging a plurality of symbols arranged in the symbol matrix; and cumulatively displaying on a second display the symbol matrices each having an arrangement of the symbols for which a payout of a credit is determined as a result of the slot games executed in the respective symbol matrices displayed on the first display.

According to the fourth aspect of the present invention, a slot game is designed to determine whether or not to pay out a credit based on an arrangement of a plurality of symbols determined by rearranging the symbols arranged in a symbol matrix. In addition, a slot game is executed in each of the plurality of symbol matrices displayed on a first display, while the second display cumulatively displays the symbol matrices, each having an arrangement of symbols for which a payout of credits is determined, as a result of the slot games executed in the respective symbol matrices displayed on the first display.

Accordingly, the second display cumulatively displays the symbol matrices, in each of which a payout of credits is determined, as a result of the slot games executed in the respective symbol matrices displayed on the first display. Thus, it is possible to provide new entertainment properties that allow a player to have expectations for cumulative display of the symbol matrices on the second display. The above configuration is also very effective in enhancing the player's motivation to play the game.

A fifth aspect of the present invention is a method for controlling a slot machine, comprising the steps of: executing a slot game, in each of a plurality of symbol matrices displayed on a first display, the slot game in which whether a credit is to be paid out or not is determined according to an arrangement determined by rearranging a plurality of symbols arranged in the symbol matrix; cumulatively displaying on a second display the symbol matrices each having an arrangement of the symbols for which a payout of a credit is determined as a result of the slot games executed in the respective symbol matrices displayed on the first display; and highlighting the symbol matrices displayed on the second display more distinctly with an increase of a number of the symbol matrices displayed on the second display.

According to the fifth aspect of the present invention, the slot game designed to determine whether or not to pay out a credit based on an arrangement of a plurality of symbols determined by rearranging the symbols arranged in the symbol matrix. In addition, a slot game is executed in each of the plurality of symbol matrices displayed on the first display, while the second display cumulatively displays the symbol matrices, each having an arrangement of symbols for which a payout of credits is determined, as a result of the slot games executed in the respective symbol matrices displayed on the first display. Moreover, the symbol matrices displayed on the second display are highlighted more distinctly as the number of the symbol matrices displayed on the second display is increased.

Accordingly, it is possible to allow the player to have higher expectations for cumulative display of the symbol matrices on the second display.

A sixth aspect of the present invention is a method for controlling a slot machine, comprising the steps of: executing a slot game, in each of a plurality of symbol matrices displayed on a first display, the slot game in which whether a credit is to be paid out or not is determined according to an arrangement determined by rearranging a plurality of symbols arranged in the symbol matrix; cumulatively displaying on a second display the symbol matrices each having an arrangement of the symbols for which a payout of a credit is determined as a result of the slot games executed in the respective symbol matrices displayed on the first display; highlighting the symbol matrices displayed on the second display more distinctly with an increase of a number of the symbol matrices displayed on the second display; and displaying a special effect image when the number of the symbol matrices displayed on the second display reaches a predetermined number.

According to the sixth aspect of the invention, the slot game designed to determine whether or not to pay out a credit based on an arrangement of the plurality of symbols determined by rearranging the symbols arranged in the symbol matrix. In addition, a slot game is executed in each of the plurality of symbol matrices displayed on the first display, while the second display cumulatively displays the symbol matrices, each having an arrangement of symbols for which a payout of credits is determined, as a result of the slot games executed in the respective symbol matrices displayed on the first display. Moreover, the symbol matrices displayed on the second display are highlighted more distinctly with an increase of the number of the symbol matrices displayed on the second display. Subsequently, a special effect image is displayed when the number of the symbol matrices displayed on the second display reaches a predetermined number.

Accordingly, it is possible to allow the player to have higher expectations for cumulative display of the symbol matrices on the second display and to make a significant impact on the player when a predetermined number of symbol matrices are accumulated on the second display.

The method may further comprise the step of resetting the symbol matrices cumulatively displayed on the second display when all the slot games executable in the plurality of symbol matrices displayed on the first display are finished.

According to the above configuration, when all the slot games executable in the plurality of symbol matrices displayed on the first display are finished, the symbol matrices cumulatively displayed on the second display are reset.

Therefore, it is possible to provide new entertainment properties that allow the player to have expectations for whether the symbol matrices are cumulatively displayed on the second display before all the slot games executable in the plurality of symbol matrices displayed on the first display are finished.

The method may further comprise the step of resetting the symbol matrices cumulatively displayed on the second display when a number of the symbol matrices cumulatively displayed on the second display reaches a predetermined maximum value.

According to the above configuration, when the number of the symbol matrices cumulatively displayed on the second display reaches a maximum value, the symbol matrices cumulatively displayed on the second display are reset.

Therefore, even if all the slot games executable in the plurality of symbol matrices displayed on the first display are finished, symbol matrices can be cumulatively displayed on the second display in the next game session. Thus, it is possible to provide new entertainment properties that allow the player to have expectations for cumulative display of the symbol matrices on the second display.

### BRIEF DESCRIPTION OF THE DRAWINGS

FIG. 1A is an explanatory view showing a display screen example on an upper display for explaining a feature of a slot machine according to an embodiment of the present invention, and FIG. 1B is an explanatory view showing a display screen example on a liquid crystal display for similarly explaining a feature of the slot machine.

FIG. 2 is a perspective view of the slot machine according to the embodiment of the present invention.

FIG. 3 is a block diagram showing a control circuit in the slot machine according to the embodiment of the present invention.

FIG. 4 is a flowchart showing a procedure executed by the slot machine according to the embodiment of the present invention.

FIG. 5 is a flowchart showing a procedure executed by the slot machine according to the embodiment of the present invention.

FIG. 6 is a flowchart showing a procedure executed by the slot machine according to the embodiment of the present invention.

FIG. 7 is a flowchart showing a procedure executed by the slot machine according to the embodiment of the present invention.

FIG. 8 is a flowchart showing a procedure executed by the slot machine according to the embodiment of the present invention.

FIG. 9 is an explanatory view showing each slot game area in the slot machine according to the embodiment of the present invention.

FIG. 10 is an explanatory view showing paylines in each slot game area in the slot machine according to the embodiment of the present invention.

FIG. 11 is an explanatory view showing relationships between combinations of symbols and payouts in the slot machine according to the embodiment of the present invention.

FIG. 12 is an explanatory view showing slot games displayed on the liquid crystal display in the slot machine according to the embodiment of the present invention.

FIG. 13 is an explanatory view showing slot games displayed on the liquid crystal display in the slot machine according to the embodiment of the present invention.

FIG. 14A is an explanatory view showing a display screen example on the upper display for explaining the feature of the slot machine, and FIG. 14B is an explanatory view showing a display screen example on the liquid crystal display for similarly explaining the feature of the slot machine.

FIG. 15A is an explanatory view showing a display screen example on the upper display for explaining the feature of the slot machine, and FIG. 15B is an explanatory view showing a display screen example on the liquid crystal display for similarly explaining the feature of the slot machine.

FIG. 16A is an explanatory view showing a display screen example on the upper display for explaining the feature of the slot machine, and FIG. 16B is an explanatory view showing a display screen example on the liquid crystal display for similarly explaining the feature of the slot machine.

### DETAILED DESCRIPTION OF THE EMBODIMENT

A slot machine to be described as an embodiment of the present invention includes a first display and a second display. The first display displays execution of a slot game designed to determine whether or not to pay out a credit, based on arrangement of a plurality of symbols determined by rearranging the symbols arranged each plurality of symbol matrices. The second display cumulatively displays the symbol matrices, each having an arrangement of symbols for which a payout of credits is determined, as a result of the slot games executed in the plurality of symbol matrices displayed on the first display.

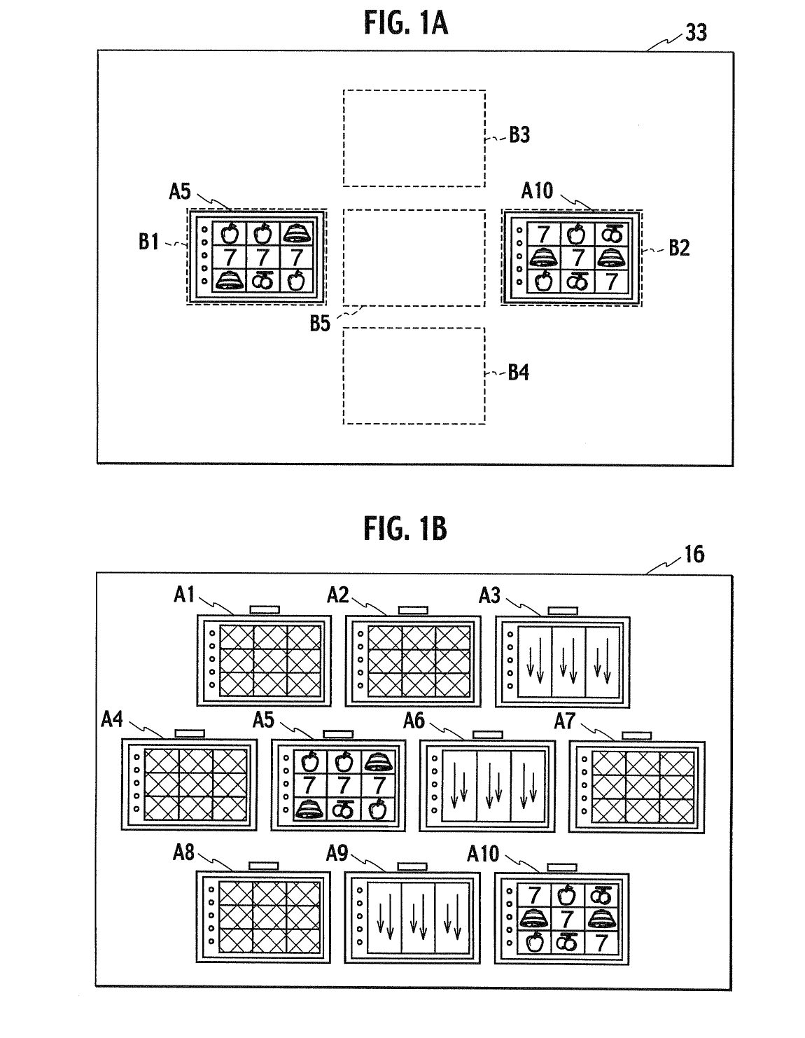

With reference to the drawings, features of the embodiment of the present invention will be described below. FIG. 1A shows an example of a display screen displayed on an upper display in the slot machine according to the embodiment of the present invention. FIG. 1B shows an example of a display screen displayed on a liquid crystal display in the slot machine according to the embodiment of the present invention. As shown in FIG. 1B, ten slot game areas A1 to A10 are provided in a liquid crystal display 16. In each of the slot game areas A1 to A10, a slot game can be executed.

Specifically, in each of the slot game areas A1 to A10, 3 rows×3 columns, a total of 9 display regions are provided. When a bet is made by inserting medals or pressing a BET switch 25 and a start switch 27 is subsequently pressed, the following slot game is executed. Specifically, symbols displayed in the display regions in 3 rows×3 columns are scrolled and the scrolling symbols are stopped in the respective display regions. Here, stops of the scrolling symbols in a new arrangement are referred to as a “rearrangement”.

In the slot game corresponding to each of the slot game areas A1 to A10, credits equivalent to a maximum of 3 medals, for example, can be bet. In each slot game, paylines are increased as the number of bets is increased.

In a slot machine 10, when medals are inserted from a medal insertion slot 21 provided below the liquid crystal display 16 or when the BET switch 25 is pressed, credits are sequentially bet on the ten slot game areas A1 to A10. In this event, a user may arbitrarily specify at least one of the slot game areas A1 to A10 on which the credits are bet, i.e., at least one of the slot game areas A1 to A10 in which the slot games start to be executed in a state where the credits are bet. Alternatively, the slot games may be automatically executed in numerical order of the slot game areas A1 to A10 in which the slot games are set to be executable. In the case where the player is allowed to specify the slot game area to start a slot game, the player can specify the slot game area by touching one of the slot game areas A1 to A10, for example. The operation of touching the slot game areas A1 to A10 by the player can be detected by a touch panel 69 provided on a surface of the liquid crystal display 16.

Therefore, for example, when the player inserts one medal from the medal insertion slot 21 after touching the slot game area A1, a credit equivalent to one medal is bet on the slot game area A1. When another medal is inserted, credits equivalent to two medals are bet on the slot game area A1.

Moreover, the following mode can also be employed. Specifically, when the player inserts medals after touching the at least one of the slot game areas A1 to A10 to specify, among the slot game areas A1 to A10, the slot game area to be executed in a state where credits are to be bet, the credits are randomly bet on the specified one of the slot game areas A1 to A10.

In the slot machine according to this embodiment, a slot game is executed in at least one slot game area in which the slot game is set to be executable among the slot game areas A1 to A10. Moreover, the slot machine is characterized in that an upper display 33 as a second display cumulatively displays symbol matrices, each having an arrangement of symbols for which a payout of credits is determined, as a result of the slot games executed on the liquid crystal display 16 as a first display.

FIGS. 1A and 1B show a state where slot games are executed respectively in the specified ones of the slot game areas A1 to A10 on the liquid crystal display 16, and where, as a result of these slot games, slot game areas each having symbol matrix that includes at least one arrangement of symbols for which a payout of credits is determined are extracted among the specified slot game areas, and displayed on the upper display 33. Specifically, FIGS. 1A and 1B show a state where: all the slot game areas A1 to A10 are specified, and slot games are executed in all the slot game areas A1 to A10; and as a result of these slot games, a combination of symbols for providing a payout of credits is determined in each of the slot game areas A10 and A5, and those slot game areas A5 and A10 are cumulatively displayed in areas B1 and B2 on the upper display 33.

The cumulative display means that the symbol matrices in the slot game areas in which at least one combination of symbols for providing a payout is determined remain to be displayed until the number of such symbol matrices reaches a predetermined number. As described in detail later, when the number of the symbol matrices in the slot game areas reaches the predetermined number, a special effect image is displayed. Moreover, the symbol matrices displayed on the upper display 33 are highlighted more distinctly with an increase of the number of the slot game areas displayed on the upper display 33.

Each of the slot game areas A1, A2, A4, A7 and A8 indicates that a combination of symbols accompanied by a payout is not established after a rearrangement is finished in the slot game. In this embodiment, those slot game areas are darkened, as an example. Moreover, each of the slot game areas A3, A6 and A9 indicates a state where the symbols are being scrolled and where a rearrangement thereof is not finished, in other words, a state where a slot game is being executed.

The slot game areas in which at least one combination of symbols leading to a payout are established as outcomes of the slot games on the liquid crystal display 16 are displayed on the upper display 33. In the slot game area A5 on the upper display 33, an “APPLE” symbol is arranged in a display region q11, a “7” symbol is arranged in a display region q12, a “BELL” symbol is arranged in a display region q13, an “APPLE” symbol is arranged in a display region q21, a “7” symbol is arranged in a display region q22, a “CHERRY” symbol is arranged in a display region q23, a “BELL” symbol is arranged in a display region q31, a “7” symbol is arranged in a display region q32, and an “APPLE” symbol is arranged in a display region q33.

Moreover, in the slot game area A10 on the upper display 33, a “7” symbol is arranged in a display region q11, a “BELL” symbol is arranged in a display region q12, an “APPLE” symbol is arranged in a display region q13, an “APPLE” symbol is arranged in a display region q21, a “7” symbol is arranged in a display region q22, a “CHERRY” symbol is arranged in a display region q23, a “CHERRY” symbol is arranged in a display region q31, a “BELL” symbol is arranged in a display region q32, and a “7” symbol is arranged in a display region q33.

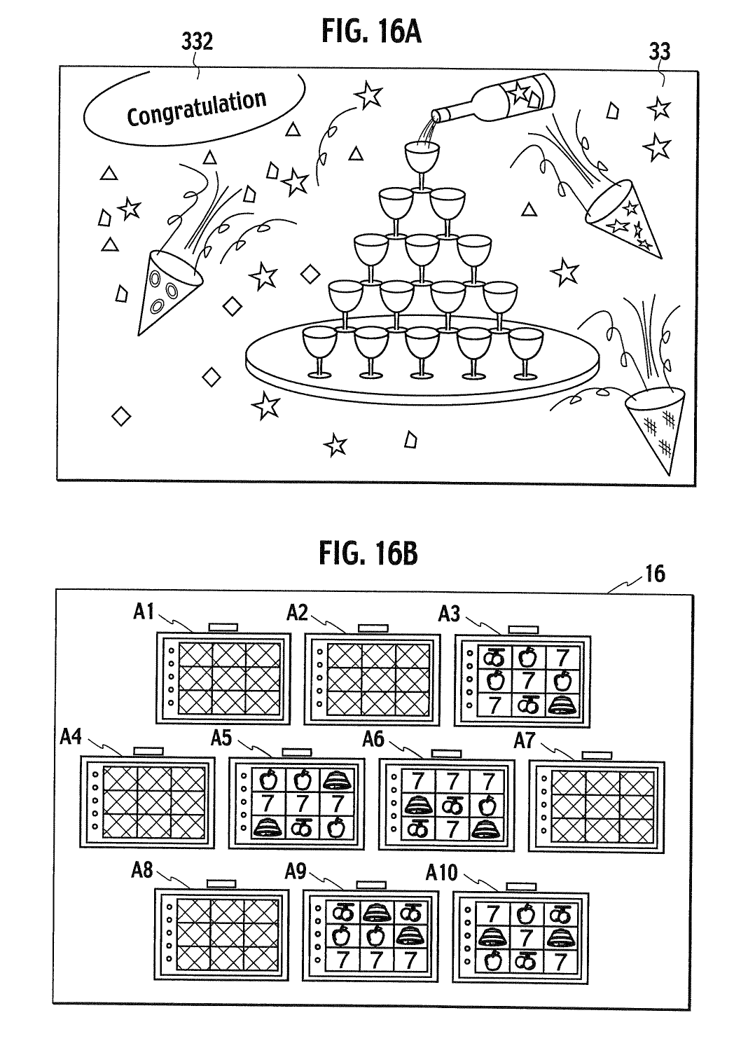

FIGS. 1A and 1B show a state in the middle of execution of slot games, when two slot game areas are being taken up on the upper display 33. In this embodiment, up to five slot game areas can be displayed in areas B1 to B5. The slot game areas displayed on the upper display 33 in a manner that the slot game areas are highlighted more distinctly with an increase of the number of the slot game areas displayed on the upper display 33, or in a manner that a special effect image is displayed when the number of the slot game areas reaches a predetermined number, for example. The slot machine 10 causes the upper display 33 to display a special effect image (see FIG. 16A) when the maximum five slot game areas are displayed thereon. The special effect image includes an effect that the five slot game areas turn into different images, a rare animation which can be seen only when the maximum five slot game areas are displayed, and the like.

As described above, the slot machine described as the embodiment of the present invention is the game machine including the slot game areas in each of which a slot game can be individually executed by taking up and displaying on the upper display 33 the symbol matrix in which the slot game is executed. The slot machine can provide new entertainment properties that allow the player to have expectations for cumulative display of the symbol matrices on the upper display 33 and thereby can also allow the player to further focus on the slot game.

The slot machine described as the embodiment of the present invention may have the following configuration. Specifically, areas in which slot games are activated among the slot game areas A1 to A10 and which displayed on the liquid crystal display 16 are determined according to the number of bets or the like, for example. Moreover, when a series of slot games in the slot game areas activated in one game session are finished, cumulative display on the upper display 33 is reset. The slot machine may also have a configuration in which, even if a series of slot games in the slot game areas activated in one game session are finished, cumulative display on the upper display 33 is not reset until the number of the slot game areas cumulatively displayed on the upper display 33 reaches a predetermined maximum value (5 in this embodiment).

Note that, in the above example, credits are bet on at least one of the slot game areas A1 to A10 by inserting medals. However, credits may be bet by use of coins, bills, bar-coded tickets and the like other than the medals. Moreover, the description was given by taking, as an example, the case where, in each slot game, stopped symbols are scrolled and the symbols are subsequently stopped again. However, the slot game is not limited to the case of scrolling the symbols. For example, the slot machine according to the present invention may have a configuration in which the symbols displayed (arranged) in the respective display regions are individually changed and new symbols are displayed (rearranged). Furthermore, in the above example, the maximum number of credits that can be bet on the respective slot game areas A1 to A10 is set to 3. However, the present invention is not limited thereto.

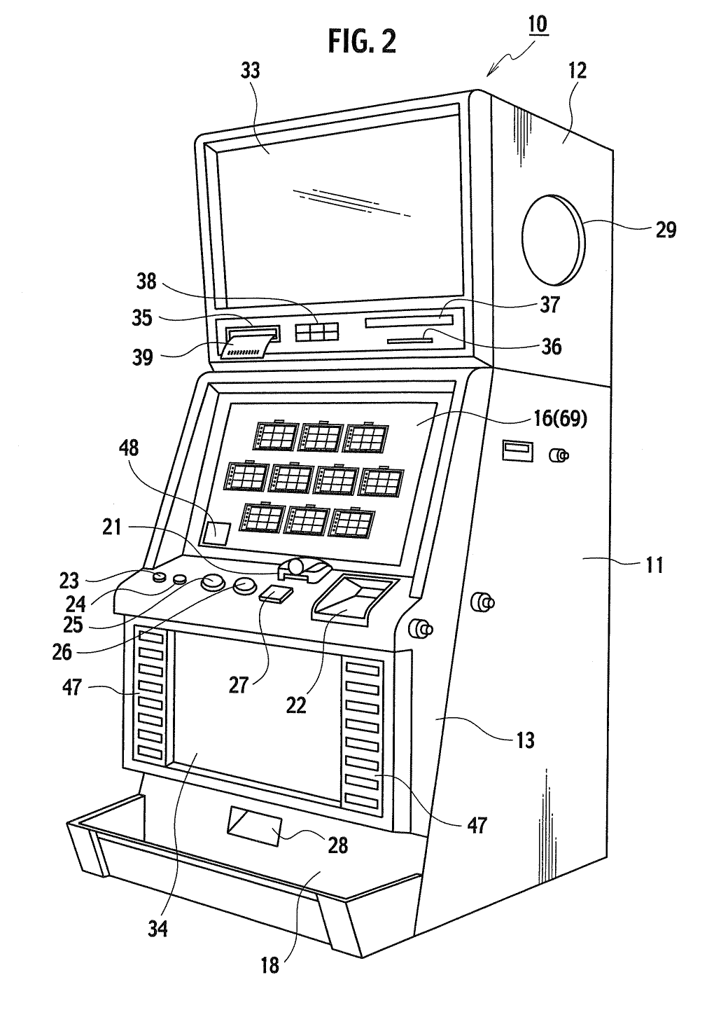

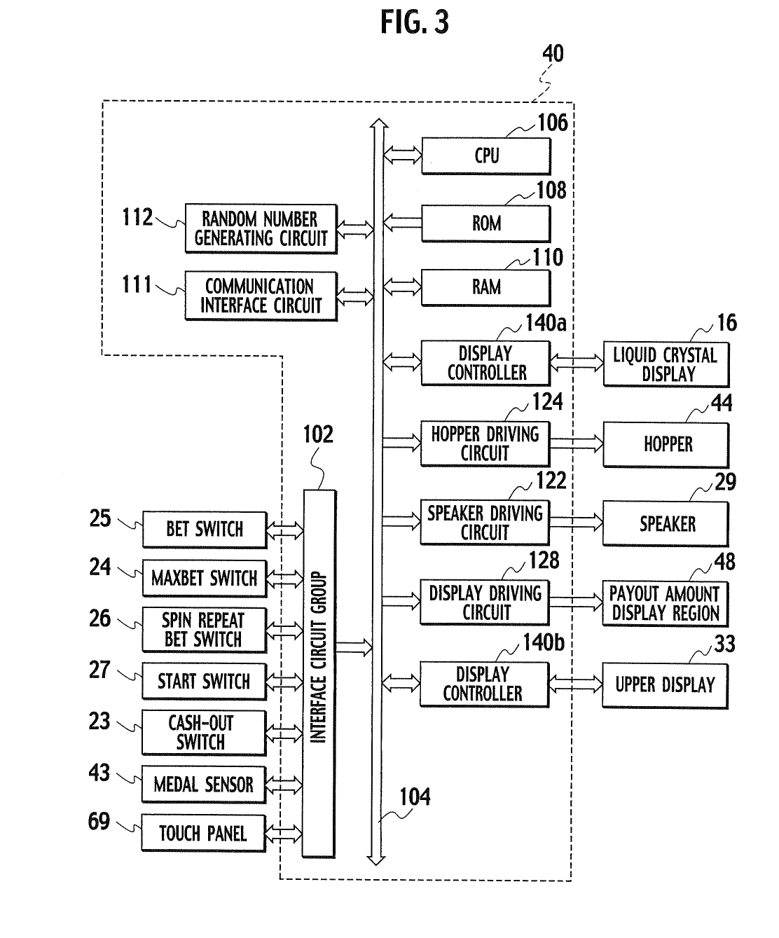

The slot machine according to the embodiment of the present invention will be described in detail below. FIG. 2 shows an external appearance of the slot machine according to the embodiment of the present invention. As shown in FIG. 2, the slot machine 10 includes a cabinet 11, a top box 12 provided on the cabinet 11 and a main door 13. The cabinet 11 has the liquid crystal display 16 provided on its surface facing the player. Moreover, inside the cabinet 11, various constituent members are provided, including a controller 40 (see FIG. 3) configured to electrically control the slot machine 10, a hopper 44 (see FIG. 3) configured to control insertion, storage and payouts of medals, and the like.

In this embodiment, medals are taken as an example of game media for supplying, to the slot machine 10, credits required to execute a game. However, the game media are not limited to the medals but may include, for example, coins, tokens, electronic money and valuable electronic information equivalent thereto.

The main door 13 is attached to the cabinet 11 so as to be openable and closable. In approximately the center of the main door 13, the liquid crystal display 16 equivalent to a first display as set forth in claims is provided. As described later, in the liquid crystal display 16, ten slot game areas A1 to A10 are provided. In the respective slot game areas A1 to A10, slot games are individually executed. When at least one combination of symbols for providing a payout is established as a result of execution of a slot game in at least one of the slot game areas A1 to A10, this slot game area is taken up and displayed on the upper display 33 to be described later. Note that, although the number of the slot game areas is set to “10” in this embodiment, the present invention is not limited thereto. It is only necessary that there exist two or more slot game areas.

In each of the slot game areas A1 to A10, 3 rows×3 columns, a total of 9 display regions are provided. In the respective display regions, various symbols are displayed. Specifically, when a slot game is started, symbols displayed (arranged) in the display regions are scrolled and then stopped (rearranged) after a predetermined period of time. In each of the slot game areas A1 to A10 in which the slot game is executed by betting at least one credit, a payout is determined (generated) according to a combination of symbols stopped in the respective display regions.

On the surface of the liquid crystal display 16, the touch panel 69 is provided. The touch panel 69 is vertically and horizontally divided into a plurality of regions in a matrix pattern. Some of the divided regions correspond to the ten slot game areas A1 to A10 displayed on the liquid crystal display 16, respectively. Specifically, when the player performs an operation of touching any one of the slot game areas A1 to A10, a position touched by the player can be identified by the touch panel 69.

Moreover, in a lower left area of the liquid crystal display 16, a payout amount display region 48 adapted to display an amount of payout is provided.

Below the liquid crystal display 16, provided are: the medal insertion slot 21 from which medals used for playing a game are inserted; and a bill validator 22 configured to validate whether or not bills are legitimate and to accept the legitimate bills. Moreover, in the vicinity of the medal insertion slot 21 and the bill validator 22, various operation switches are provided.

As the operation switches, a cash-out switch 23, a MAXBET switch 24, the BET switch 25, a spin repeat bet switch 26 and the start switch 27 are provided.

The BET switch 25 is a switch for determining the number of credits to be bet on at least one of the slot games to be respectively executed in the plurality of slot game areas A1 to A10. As described later, every time the BET switch 25 is pressed, a credit equivalent to 1 medal is bet on one of the slot game areas A1 to A10. In a slot game area on which any credit is bet among the slot game areas A1 to A10, a slot game is activated. In other words, the slot game area is set in a state that enables the slot game to be started. In the activated slot game area, a payout is determined when symbols are stopped in a predetermined combination on a payline.

The spin repeat bet switch 26 is a switch for starting a slot game in the previously bet one of the slot game areas A1 to A10 by betting credits on the previously bet one of the slot game areas A1 to A10 again without changing the number of credits bet on the slot game areas A1 to A10 by use of the BET switch 25 described above in the previous game.

The start switch 27 is a switch for starting a slot game in the slot game area in which the slot game is activated after a desired number of credits are bet on at least one of the plurality of slot game areas A1 to A10. When the start switch 27 is pressed after medals are inserted from the medal insertion slot 21 or credits are bet by use of the BET switch 25, the slot game is started in the activated slot game area. Thereafter, when at least one combination of symbols for providing a payout is established in any of the slot game area, this slot game area is displayed on the upper display 33.

The cash-out switch 23 is a switch for paying out the inserted medals. The medals to be paid out are discharged from a medal payout opening 28 provided in a lower part of a front of the main door 13. The discharged medals are accumulated in a medal tray 18.

The MAXBET switch 24 is a switch for betting, in one operation, the maximum number of credits (for example, equivalent to 30 medals) that can be bet on one game.

On a lower front surface of the main door 13, a foot display 34 is provided, on which various images related to games run on the slot machine 10 are displayed. The images include characters of the slot machine 10 and the like.

On both sides of the foot display 34, lamps 47 are provided, which emit light based on illumination patterns which are respectively preset for plays performed on the slot machine 10. Below the foot display 34, the medal payout opening 28 is provided.

On the front surface of the top box 12, the upper display 33 equivalent to a second display as set forth in claims is provided. The upper display 33 includes a display panel. A slot game area in which at least one combination of symbols for providing a payout is established among the plurality of slot game areas is taken up and displayed on the upper display 33.

In the top box 12, a speaker 29 is provided. Below the upper display 33, a ticket printer 35, a card reader 36, a data display 37 and a keypad 38 are provided. The ticket printer 35 prints out a bar-code on a ticket, the bar-code having coded data such as the number of credits, time and date and an identification number of the slot machine 10, and outputs the ticket as a bar-coded ticket 39.

The player can play a game on another slot machine by allowing the slot machine to read the bar-coded ticket 39 or change the bar-coded ticket 39 for bills and the like at a predetermined location in a game arcade (hall) (for example, a cashier in a casino).

The card reader 36 allows a smart card to be inserted thereinto, reads data from the inserted smart card and writes data into the smart card. The smart card is a card carried by the player and stores data for identifying the player, data on a history of games played by the player, and the like.

FIG. 3 shows the controller 40 provided in the slot machine 10 according to this embodiment and an electrical configuration of various devices connected to the controller 40. The controller 40 in the slot machine 10 shown in FIG. 3 is a microcomputer, including an interface circuit group 102, an input-output (I/O) bus 104, a central processing unit (CPU) 106, a read-only memory (ROM) 108, a random access memory (RAM) 110, a communication interface circuit 111, a random number generating circuit 112, a speaker driving circuit 122, a hopper driving circuit 124, a display driving circuit 128 and display controllers 140a and 140b. The liquid crystal display 16 is connected to the display controller 140a and the upper display 33 is connected to the display controller 140b.

The interface circuit group 102 is connected to the I/O bus 104. The I/O bus 104 inputs and outputs a data signal and an address signal to and from the CPU 106.

The start switch 27 is connected to the interface circuit group 102. A start signal outputted from the start switch 27 is transmitted, after converted into a predetermined signal by the interface circuit group 102, to the CPU 106 through the I/O bus 104.

The BET switch 25, the MAXBET switch 24, the spin repeat bet switch 26 and the cash-out switch 23 are further connected to the interface circuit group 102. Respective switching signals outputted from those switches 25, 24, 26 and 23 are supplied to the interface circuit group 102 and transmitted, after converted into predetermined signals by the interface circuit group 102, to the CPU 106 through the I/O bus 104.

In addition, a medal sensor 43 is connected to the interface circuit group 102. The medal sensor 43 is a sensor for detecting medals inserted from the medal insertion slot 21 and is provided in a medal insertion part of the medal insertion slot 21. A detection signal outputted from the medal sensor 43 is supplied to the interface circuit group 102 and transmitted, after converted into a predetermined signal by the interface circuit group 102, to the CPU 106 through the I/O bus 104.

Moreover, the touch panel 69 is connected to the interface circuit group 102. The touch panel 69 is for detecting an operation of touching, by the player, the ten slot game areas A1 to A10 displayed on the liquid crystal display 16. The touch panel 69 is provided on the surface of the liquid crystal display 16. A position detection signal outputted from the touch panel 69 is supplied to the interface circuit group 102 and transmitted, after converted into a predetermined signal by the interface circuit group 102, to the CPU 106 through the I/O bus 104.

The ROM 108 storing system programs and the RAM 110 for storing various data are connected to the I/O bus 104. The random number generating circuit 112, the communication interface circuit 111, the display controllers 140a and 140b, the hopper driving circuit 124, the speaker driving circuit 122 and the display driving circuit 128 are further connected to the I/O bus 104.

Upon receipt of a game start operation from the start switch 27, the CPU 106 executes a game by reading from the ROM 108 a game execution program among the system programs stored in the ROM 108. The game execution program is a program for allowing the CPU 106: to extract a slot game area in which at least one combination of symbols for providing a payout is established in the slot game from the slot game areas A1 to A10 displayed on the liquid crystal display 16 through the display controllers 140a and 140b; to store the extracted area in the RAM 110; to display the area on the upper display 33; and to display a special effect image when the number of the slot game areas reaches a predetermined upper limit.

To be more specific, the game execution program is a program for allowing the CPU 106 to execute the following slot game. Specifically, in each of the slot game areas in which the slot games are activated, among the slot game areas A1 to A10, symbols are scrolled and subsequently stopped. When the stopped symbols are rearranged in a predetermined combination on an activated payline, a payout corresponding to the combination is determined. Thereafter, the arrangement of the symbols in the slot game area in which the slot game that has resulted in the payout is executed is displayed on the upper display 33. Subsequently, a special effect image is displayed when the number of the slot game areas displayed on the upper display 33 reaches a predetermined upper limit.

The communication interface circuit 111 is connected to an arcade server (a hall server) and the like and transmits to the arcade server data on a history of plays executed in the slot machine 10 and the like. Moreover, the communication interface circuit 111 receives various data transmitted from the arcade server.

The random number generating circuit 112 generates a random number for determining whether or not to generate a combination of symbols leading to a payout in an activated one of the slot games in the respective slot game areas A1 to A10.

The display driving circuit 128 performs control of displaying an amount of payout on the payout amount display region 48 set in the lower left area of the liquid crystal display 16.

The speaker driving circuit 122 outputs sound data to the speaker 29. Specifically, the CPU 106 reads sound data stored in the ROM 108 and transmits the sound data to the speaker driving circuit 122 through the I/O bus 104. Thus, predetermined sound effects are emitted from the speaker 29.

The hopper driving circuit 124 outputs a payout signal to the hopper 44 when a cash-out occurs. Specifically, when a cash-out signal is inputted from the cash-out switch 23, the CPU 106 outputs a driving signal to the hopper driving circuit 124 through the I/O bus 104. Thus, the hopper 44 pays out medals equivalent to the number of credits remaining at the time, which are stored in a predetermined memory region of the RAM 110.

The display controller 140a starts slot games one by one or all at once in the slot game areas in which the slot games are activated, among the plurality of slot game areas A1 to A10 provided on the liquid crystal display 16. The CPU 106 generates an image display command signal corresponding to an effect image representing that the symbols are scrolled and then stopped and an outcome of the slot game for each of the slot game areas, and outputs the image display command signal to the display controller 140a through the I/O bus 104. Upon receipt of the image display command signal outputted from the CPU 106, the display controller 140a generates a driving signal for driving the liquid crystal display 16 according to the image display command and outputs the generated driving signal to the liquid crystal display 16. Thus, a predetermined image is displayed on the liquid crystal display 16.

The display controller 140b performs control for displaying an effect image on the upper display 33. Specifically, the CPU 106 displays on the upper display 33 the arrangement of the symbols in at least one slot game area in which a slot game is executed and in which a payout is determined as an outcome of the slot game. Here, slot games are executed in the activated ones of the slot game areas A1 to A10 displayed on the liquid crystal display 16. Thereafter, a special effect image (see FIG. 16A) is displayed when the number of the slot game areas on the upper display 33 reaches a predetermined upper limit. The CPU 106 generates an image display command signal corresponding to an outcome of the slot game, and outputs the image display command signal to the display controller 140b through the I/O bus 104. Upon receipt of the image display command signal outputted from the CPU 106, the display controller 140b generates a driving signal for driving the upper display 33 according to the image display command and outputs the generated driving signal to the upper display 33. Thus, a predetermined image is displayed on the upper display 33.

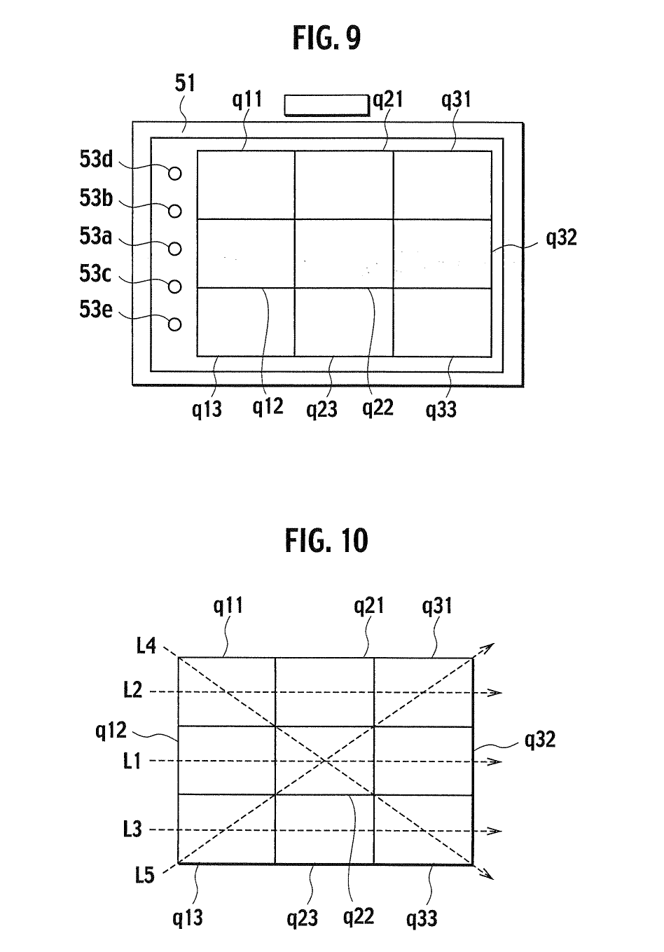

Next, with reference to FIG. 9, description will be given of an image displayed in each of the slot game areas A1 to A10. FIG. 8 shows a display example in each of the slot game areas A1 to A10.

As shown in FIG. 9, 3 rows×3 columns, a total of 9 display regions q11 to q33 are provided in each of the slot game areas A1 to A10. When a slot game is executed, various scrolling symbols are displayed in those nine display regions q11 to q33.

To the left of the display regions q11 to q33, five light emitting diodes (LEDs) 53a to 53e are provided. Which and how many LEDs to be turned on among the LEDs 53a to 53e is determined according to the number of bets. To be more specific, when a credit equivalent to 1 medal is bet on one of the slot game areas A1 to A10, the LED 53a is turned on in this slot game area. When credits equivalent to 2 medals are bet on one of the slot game areas A1 to A10, the LEDs 53b and 53c in addition to the LED 53a are turned on in this slot game area. When credits equivalent to 3 medals are bet in one of the slot game areas A1 to A10, the LEDs 53d and 53e in addition to the LEDs 53a to 53c are turned on in this slot game area.

The LEDs 53a to 53e are provided to notify respective paylines in each of the slot game areas A1 to A10. FIG. 10 is an explanatory view showing paylines in each of the slot game areas A1 to A10. In 3 rows×3 columns, a total of 9 display regions q11 to q33, it is assumed that a center horizontal line is L1, that an upper horizontal line is L2, that a lower horizontal line is L3, that a downward sloping line is L4 and that an upward sloping line is L5.

The line L1 is set as a payline when the LED 53a shown in FIG. 9 is turned on, the lines L2 and L3 are set as paylines when the LEDs 53b and 53c are turned on, and the lines L4 and L5 are set as paylines when the LEDs 53d and 53e are turned on. Accordingly, only the line L1 serves as a payline when a credit equivalent to 1 medal is bet, the lines L1 to L3 serve as paylines when credits equivalent to 2 medals are bet, and all the lines L1 to L5 serve as paylines when credits equivalent to 3 medals are bet. When the symbols are rearranged in a predetermined combination on any of these paylines set in the above-described manner, a payout corresponding to the combination is determined.

An activated area notifying frame 51 is provided around the display regions q11 to q33. When the slot game is activated in one of the slot game areas A1 to A10, the activated area notifying frame 51 is lighted up in this slot game area. When at least a credit equivalent to 1 medal is bet on one of the slot game areas A1 to A10, the activated area notifying frame 51 is lighted up in this slot game area. Thus, the player can easily recognize the activated slot game area among the ten slot game areas A1 to A10.

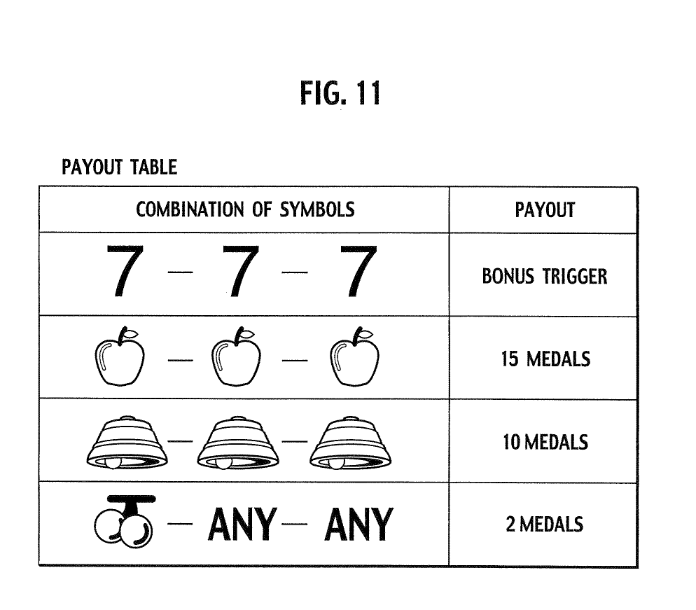

FIG. 11 is an explanatory view showing combinations of symbols leading to payouts. As shown in FIG. 11, if “7” symbols are lined up on a payline, in other words, if, for example, three “7” symbols are lined up on the line L1 when the line L1 shown in FIG. 10 is set as a payline, a bonus game is started. The bonus game means a game that provides a gaming state advantageous to the player, such as a state where a predetermined number of slot games can be executed without making bets, or that provides a special payout. Meanwhile, if “APPLE” symbols are lined up, a payout equivalent to 15 medals is determined. Likewise, if “BELL” symbols are lined up, a payout equivalent to 10 medals is determined, and if a “CHERRY” symbol is stopped on any of the display regions on the left side, a payout equivalent to 2 medals is determined.

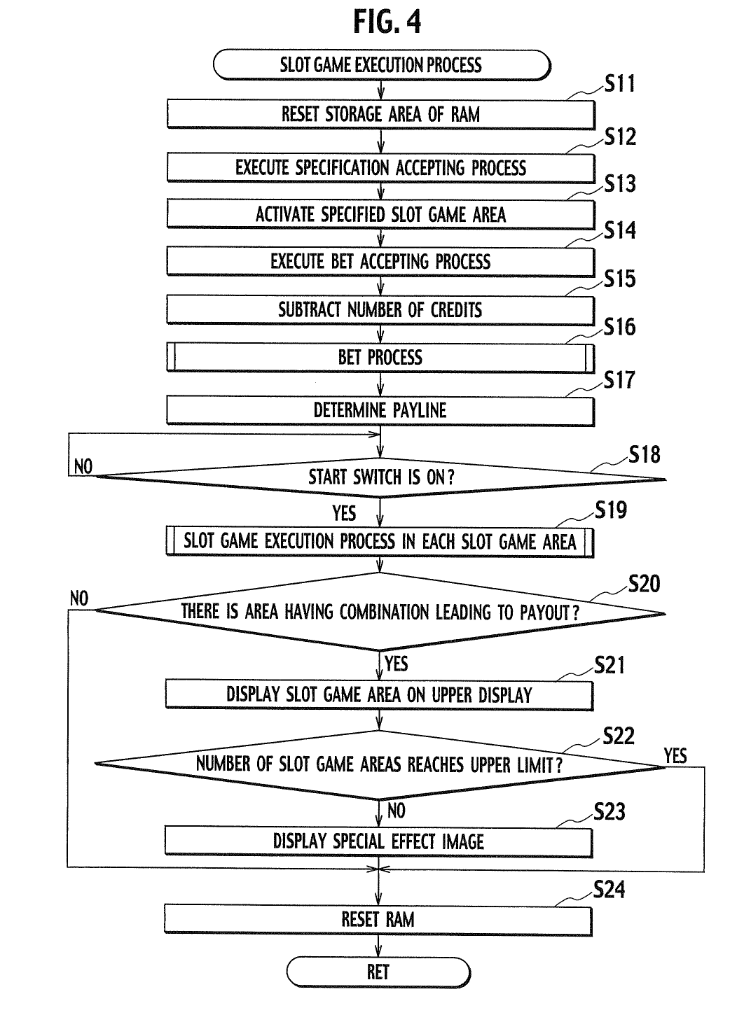

Next, with reference to flowcharts shown in FIGS. 4 to 8, operations of the slot machine according to this embodiment will be described. With reference to FIG. 4, description will be given of a slot game execution process carried out by the CPU 106 according to the game execution program stored in the ROM 108. As a method for cumulatively displaying the slot game areas on the upper display 33 in the slot machine 10, the following methods can be employed. One is a method for resetting symbol matrices cumulatively displayed on the upper display 33 when all slot games executable in a plurality of symbol matrices displayed on the liquid crystal display 16 are finished. The other is a method for resetting symbol matrices cumulatively displayed on the upper display 33 when the number of the symbol matrices cumulatively displayed on the upper display 33 reaches a maximum value.

First, with reference to FIG. 4, description will be given of operations of the slot machine 10 in the case of employing the method for resetting symbol matrices cumulatively displayed on the upper display 33 when all slot games executable in a plurality of symbol matrices displayed on the liquid crystal display 16 are finished.

The CPU 106 first resets the symbol matrices displayed on the upper display 33 (Step S11). To be more specific, what is reset here is an area of the RAM 110 storing information related to the symbol matrices displayed on the upper display 33.

Next, the CPU 106 performs a specification accepting process for accepting specification, by the player, of at least one of the slot game areas A1 to A10 to be activated (Step S12). In this specification accepting process, the CPU first determines, on the basis of a position detection signal from the touch panel 69, the slot game area touched by the player so as to be specified as a slot game area to be activated among the slot game areas A1 to A10. The CPU 106 then activates the specified one of the slot game areas A1 to A10 that is determined in the above-described manner as a slot game area in which a slot game is executed (Step S13). In the activated one of the slot game areas A1 to A10, the activated area notifying frame 51 provided in the peripheral portion of this slot game area is lighted up by the CPU 106. Thus, the activated one of the slot game areas A1 to A10 is notified to the player.

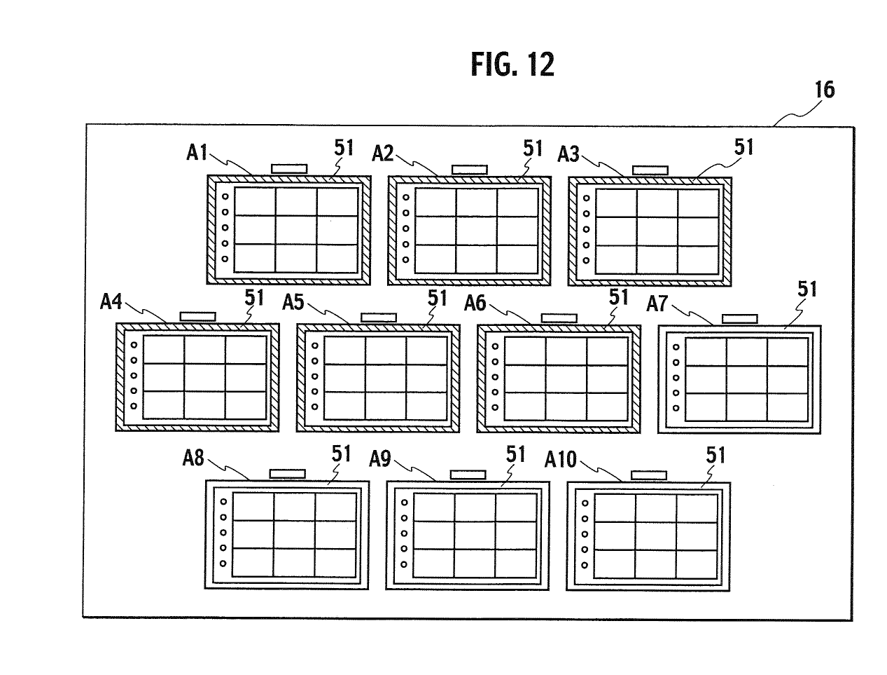

As an example of activation of the slot game areas, when the slot game areas A1 to A6, for example, are specified by the player, the activated area notifying frames 51 in the slot game areas A1 to A6 are lighted up as shown in FIG. 12, thereby indicating that the slot game areas A1 to A6 have been activated. Here, the slot game areas A7 to A10 which are not specified are not activated. Thus, none of the activated area notifying frames 51 in the slot game areas A7 to A10 is lighted up.

Next, the CPU 106 performs a bet accepting process for accepting credits bet on the activated one of the slot game areas A1 to A10 (Step S14). In this bet accepting process, the CPU determines the number of the bet credits by detecting an operation of pressing the BET switch 25 by the player. Thereafter, the CPU 106 subtracts the number of the bet credits from the number of current credits (Step S15). For example, if “30” credits are bet when the number of current credits is “50”, “30” credits are subtracted from “50” credits to leave “20” credits.

Note that credits can also be bet on the slot game in the activated one of the slot game areas A1 to A10 by inserting medals from the medal insertion slot 21 by the player. In this case, the CPU 106 recognizes the number of medals inserted from the medal insertion slot 21 by the player as the number of credits to be bet. When credits are bet by inserting medals from the medal insertion slot 21, it is not required to perform the subtraction of credits in Step S14.

Note that the process shown in FIG. 4 has been described by taking the case where the game areas to be activated can be specified by the player. However, the present invention may also be applied to a configuration in which a bet operation is previously performed by the player and thus arbitrary game areas are automatically selected and sequentially activated according to the number of bets.

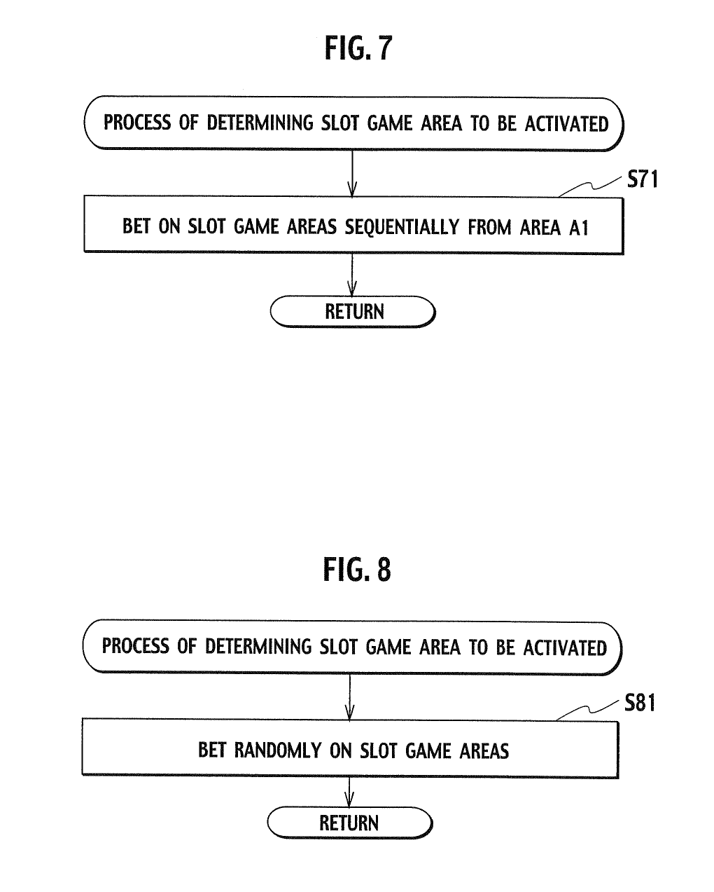

Next, the CPU 106 performs a bet process for betting credits on the slot games in the activated slot game areas A1 to A10 (Step S16). This process will be described in detail later with reference to FIGS. 7 and 8.

After completing the process of betting credits on the slot game in the activated one of the slot game areas A1 to A10, the CPU 106 determines at least one payline in the activated one of the slot game areas A1 to A10 according to the number of credits bet on the slot game in the activated one of the slot game areas A1 to A10 (Step S17). As described above, this process is performed as follows. Specifically, when a credit equivalent to 1 medal is bet on a slot game in one of the slot game areas A1 to A10, the line L1 shown in FIG. 10 is activated in this slot game area. When credits equivalent to 2 medals are bet on a slot game in one of the slot game areas A1 to A10, the lines L1 to L3 are activated in this slot game area. When credits equivalent to 3 medals are bet on a slot game in one of the slot game areas A1 to A10, all the lines L1 to L5 are activated in this slot game area.

Moreover, as described later, when credits are randomly bet on the slot games in the slot game areas A1 to A10 (see FIG. 8), it is not necessarily the case that the credits are bet in numerical order of the slot game areas A1 to A10. For example, in the case where the slot game areas A1, A3, A6, A8 and A10 are activated by the player in Step S11, there is performed a process in which the number of the bet credits are randomly allocated to the respective specified slot game areas. Specifically, first, a credit equivalent to 1 medal is allocated to the slot game in the slot game area A8. Next, a credit equivalent to 1 medal is allocated to the slot game in the slot game area A3. Thereafter, a credit equivalent to 1 medal is allocated to the slot game in the slot game area A10. Subsequently, a credit equivalent to 1 medal is allocated to the slot game in the slot game area A1. Finally, a credit equivalent to 1 medal is allocated to the slot game in the slot game area A6. A bet credit is randomly allocated to one of the slot game areas as described above every time a bet is repeated.

Here, with reference to the flowchart shown in FIG. 7, the bet process in Step S16 in the flowchart shown in FIG. 4 will be described. When the BET switch 25 is pressed or medals are inserted from the medal insertion slot 21, the CPU 106 first bets credits sequentially in ascending order of the area number, A1, A2, A3 . . . , on the slot game areas activated by the process in Step S13 in the flowchart shown in FIG. 4 among the slot game areas A1 to A10 (Step S71).

Meanwhile, FIG. 8 is a flowchart showing another procedure of the bet process in Step S16 in the flowchart shown in FIG. 4. In this process, when the BET switch 25 is pressed, as in the case of FIG. 7, the CPU 106 first bets credits randomly on the slot game areas activated by the process in Step S13 in the flowchart shown in FIG. 4 among the slot game areas A1 to A10 (Step S81). In this event, the order of betting credits on the slot games in the slot game areas in which a bonus game is not being executed among the slot game areas A1 to A10 is arbitrarily determined by the CPU 106 and randomly determined for each game.

Thereafter, the CPU 106 determines whether or not the start switch 27 is turned on (Step S18). If the start switch 27 is turned on, the CPU 106 performs a series of processes for executing the slot games in the order either specified by the player or automatically selected, out of the activated ones of the slot game areas A1 to A10 (Step S19).

The CPU 106 determines whether or not the activated ones of the slot game areas A1 to A10 include a symbol matrix in which at least one combination of symbols leading to a payout is established as an outcome of the slot game executed therein (Step S20). If such a symbol matrix is found, the arrangement of symbols in the slot game area having this symbol matrix is displayed on the upper display 33 (Step S21).

Next, the CPU 106 determines whether or not the number of the slot game areas displayed on the upper display 33 reaches a predetermined upper limit (Step S22). In this embodiment, the upper limit is 5. When the number of the slot game areas displayed on the upper display 33 reaches (Step S22: Yes), the CPU 106 displays a special effect image (see FIG. 16A) (Step S23). Thereafter, the CPU 106 resets the symbol matrices displayed on the upper display 33 (Step S24) and repeats the processes from Step S11.

When it is determined in Step S20 that the activated ones of the slot game areas A1 to A10 include no symbol matrix in which at least one combination of symbols leading to a payout is established (Step S20: No) or it is determined in Step S22 that the number of the slot game areas displayed on the upper display 33 does not reach the predetermined upper limit (Step S22: No), the CPU 106 repeats the processes from Step S11 without going through Steps S21 and S23.

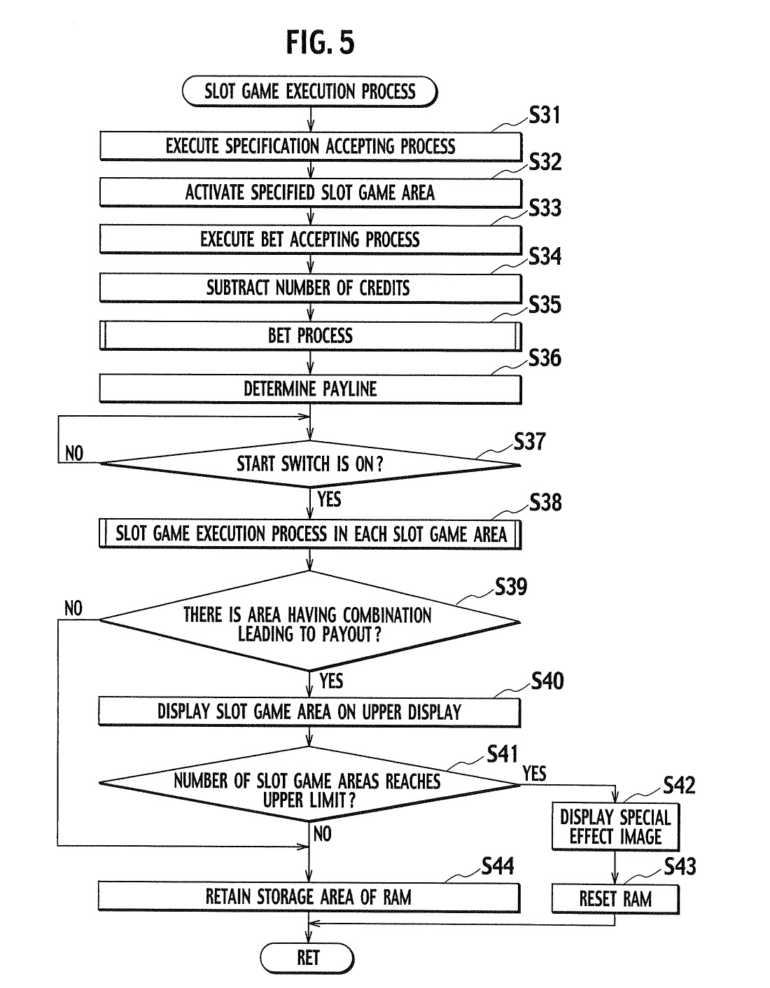

Next, with reference to FIG. 5, description will be given of operations of the slot machine 10 in the case of employing the method for resetting symbol matrices cumulatively displayed on the upper display 33 when the number of the symbol matrices cumulatively displayed on the upper display 33 reaches a maximum value. In the case of the operations shown in FIG. 5, the information related to the symbol matrices displayed on the upper display 33, which is stored in the RAM 110, is not reset for each game. Moreover, in this processing, Steps S31 to S40 correspond to Steps S12 to S21 shown in FIG. 4.

When the activated ones of the slot game areas A1 to A10 include a symbol matrix in which at least one combination of symbols leading to a payout is established as an outcome of the slot game executed therein, the CPU 106 displays on the upper display 33 the arrangement of symbols in the slot game area having this symbol matrix (Step S40). Thereafter, the CPU 106 determines whether or not the number of the slot game areas displayed on the upper display 33 reaches a predetermined upper limit (Step S41). In this embodiment, the upper limit is 5. When the number of the slot game areas displayed on the upper display 33 reaches 5 (Step S41: Yes), the CPU 106 displays a special effect image (see FIG. 16A) (Step S42). Subsequently, the CPU 106 resets the symbol matrices displayed on the upper display 33 (Step S43) and repeats the processes from Step S31.

When it is determined in Step S39 that he activated ones of the slot game areas A1 to A10 include no symbol matrix in which at least one combination of symbols leading to a payout is established (Step S39: No) or it is determined in Step S41 that the number of the slot game areas displayed on the upper display 33 does not reach the predetermined upper limit (Step S41: No), the information related to the symbol matrices displayed on the upper display 33, which is stored in the RAM 110, is retained (Step S44). Thereafter, the CPU 106 repeats the processes from Step S31.

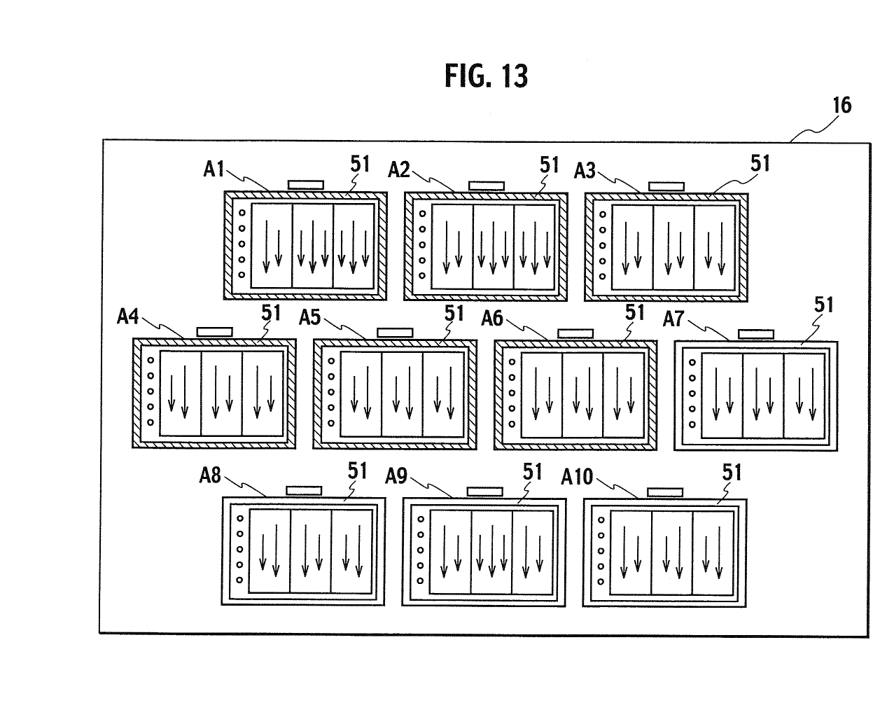

FIG. 13 shows a display screen example of the liquid crystal display 16 in the case where slot games are started in the activated ones of the slot game areas A1 to A10 when the start switch 27 is turned on. The display screen example shown in FIG. 13 indicates a state where all the slot game areas A1 to A10 are activated by the player and the slot games are started in all the slot game areas.

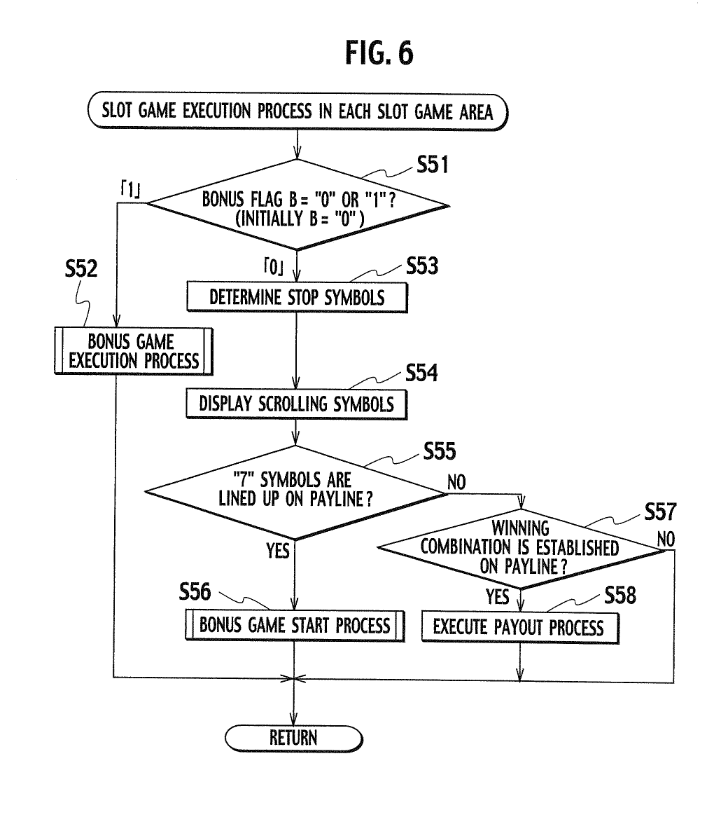

Next, with reference to FIG. 6, description will be given of a procedure of processing slot games executed in the specified (activated) ones of the slot game areas A1 to A10. Here, description will be given by taking, as an example, a slot game executed in the slot game area A5.

As described with reference to FIGS. 1A and 1B, the CPU 106 first determines whether a bonus flag is “0” or “1” in each of the activated ones of the slot game areas A1 to A10 (Step S51). The bonus flag is initially set to “0”, and becomes “1” when a bonus game is executed. In the next or subsequent games, when the bonus flag is “1”, a bonus game execution process is performed in Step S52.

Next, the CPU 106 determines which symbols to be stopped in the respective display regions q11 to q33 in each of the activated slot game area (Step S53). By this process, the symbols (“7”, “BELL”, “APPLE” and the like) to be displayed in the respective display regions q11 to q33 are determined.

Thereafter, the CPU 106 scrolls the symbols in the display regions q11 to q33 in each of the activated slot game area (Step S54). After a predetermined period of time, symbols are stopped in the respective display regions q11 to q33. Here, the symbols determined in Step S53 are stopped to be displayed in the respective display regions.

Subsequently, the CPU 106 determines whether or not “7” symbols, are lined up on a payline, the combination indicating a bonus trigger (Step S55). For example, when all of the five lines L1 to L5 shown in FIG. 10 are set as paylines, the CPU 106 determines whether or not the “7” symbols are lined up on any one of those paylines L1 to L5.

When the “7” symbols are lined up on any one of the paylines L1 to L5, the bonus trigger is established and a bonus game start process is executed by the CPU 106 (Step S56). The bonus game means a game that provides a gaming state advantageous to the player, such as a state where a predetermined number of slot games can be executed without making bets by the player, or that provides a special payout. When the “7” symbols are lined up on any of the paylines to establish the bonus trigger in the process of Step S56 in FIG. 6, the CPU 106 sets the bonus flag to “1”. Thereafter, the CPU 106 determines the number of bonus games T. For example, the number of bonus games T may be determined to be a constant number of games, such as 50, or may be randomly determined by the CPU 106 in each case. The number of bonus games T is stored in the RAM 110. The player can make bets without losing credits during the determined number of bonus games.

When the “7” symbols are not lined up on any of the paylines, the CPU 106 determines whether or not another combination that can provide a payout is established on any of the paylines (Step S57). If such a combination of symbols is established, a payout in an amount corresponding to the combination is determined (Step S58). When a predetermined combination is not established on any of the paylines, the CPU 106 generates no payout and finishes the slot game in the slot game area. Note that, in the case of generating a payout, the medals equivalent to the payout may be paid out from the medal payout opening 28 or credits equivalent to the payout may be added to the current credits.

The operations of the slot machine 10 shown in FIGS. 4 and 5 described above will be concretely described below by use of the display screen examples. The state shown in FIGS. 1A and 1B is assumed to be obtained as a result of execution of the slot game execution process shown in FIG. 6 after the display screen shown in FIG. 13 is displayed. Note that the display screen examples shown in FIGS. 1A and 1B are in a state where some of the slot games are not finished in the specified slot game areas.

FIGS. 1A and 1B show a state where slot games are executed respectively in the specified ones of the slot game areas A1 to A10 on the liquid crystal display 16, and where, as a result of these slot games, slot game areas each having symbol matrix that includes at least one arrangement of symbols for which a payout of credits is determined are extracted among the specified slot game areas, and displayed on the upper display 33. Specifically, FIGS. 1A and 1B show a state where: all the slot game areas A1 to A10 are specified, and slot games are executed in all the slot game areas A1 to A10; and as a result of these slot games, a combination of symbols for providing a payout of credits is determined in each of the slot game areas A10 and A5, and those slot game areas A5 and A10 are cumulatively displayed in areas B1 and B2 on the upper display 33.

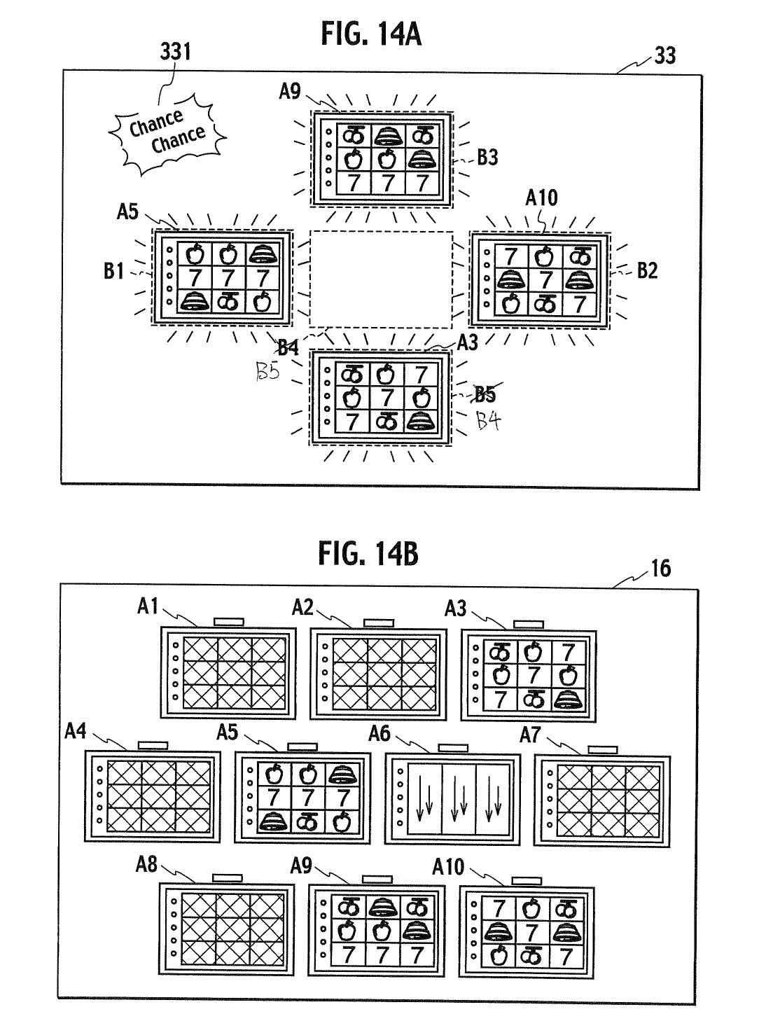

FIGS. 14A and 14B show a state where the slot games executed in the slot game areas A3 and A9 are finished after a state represented by the display screens shown in FIGS. 1A and 1B and combinations of symbols each leading to a payout are established in both of the slot game areas. By performing the processes in Steps S19 to S21 in FIG. 4 or Steps S38 to S40 in FIG. 5, the symbol matrices in which the symbols are rearranged in the slot game areas A3 and A9 are displayed in areas B3 and B4 on the upper display 33.

At this point, four symbol matrices are accumulated on the upper display 33. The displayed symbol matrices has been highlighted more distinctly with an increase of the number of the symbol matrices displayed on the upper display 33, and are more distinctly highlighted than those in the display screen example shown in FIG. 1A. For example, in FIG. 14A showing the four symbol matrices displayed, brightness is increased compared with the case where the two symbol matrices are displayed in FIG. 1A. Moreover, a character image 331 “Chance Chance!” is also displayed to achieve an effect that further heightens expectations of the player.

In the embodiment described above, as an example, the symbol matrices are arranged in the form of a cross on the upper display 33. Moreover, the symbol matrices taken up from the liquid crystal display 16 since at least one combination of symbols leading to a payout is established in each of the symbol matrices are accumulated on the upper display 33 in the order of the areas B1, B2, B3, B4 and B5. Therefore, a state where only the last area B5 remains heightens the expectations of the player, thereby allowing the player to focus on the slot game.

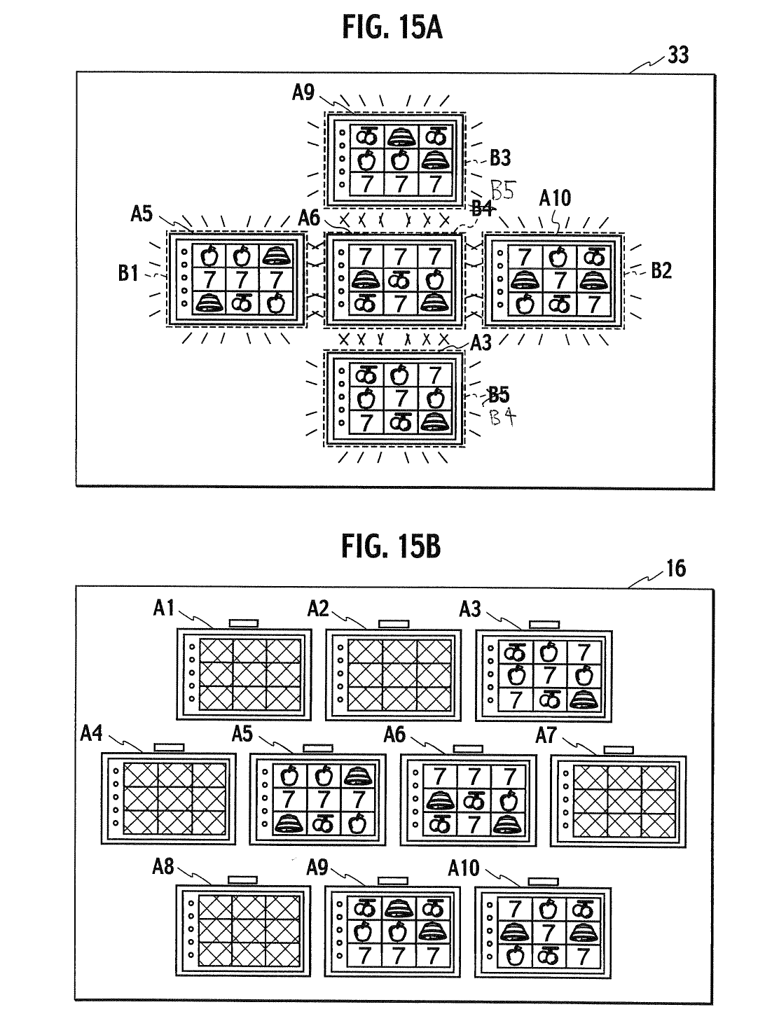

FIGS. 15A and 15B show a state where the slot game executed in the last slot game area A6 are completed, after a state represented by the display screens shown in FIGS. 14A and 14B where the symbols were being scrolled in the slot game area A6. Moreover, in FIGS. 15A and 15B, as a result of the slot game and rearrangement of the symbols in the last slot game area A6, a combination of symbols leading to a payout is established. As a result, the symbol matrix in the slot game area A6 is displayed in the area B5 on the upper display 33, as shown in FIG. 15A, and thus all the areas on the upper display 33 are filled in.

In this event, the CPU 106 performs the process of Step S23 in FIG. 4 or Step S42 in FIG. 5 to display a special effect image shown in FIG. 16A. FIG. 16A shows an example of the special effect image displayed on the upper display 33. On the upper display 33, a character image 332 “Congratulation” is displayed. This special effect image may be an effect image displayed only when five symbol matrices are displayed on the upper display 33 and is not limited to the example shown in FIG. 16A.

The slot machine described as the embodiment of the present invention may have the following configuration. Specifically, areas in which slot games are activated among the slot game areas A1 to A10 and which displayed on the liquid crystal display 16 are determined according to the number of bets or the like, for example. Moreover, when a series of slot games in the slot game areas activated in one game session are finished, cumulative display on the upper display 33 is reset (see FIG. 4). The slot machine may also have a configuration in which, even if a series of slot games in the slot game areas activated in one game session are finished, cumulative display on the upper display 33 is not reset until the number of the slot game areas cumulatively displayed on the upper display 33 reaches a maximum value (5 in this embodiment) (see FIG. 5).

In FIG. 1A, FIG. 14A and FIG. 15A, “7-7-7” is cited as the combination of symbols leading to a payout. However, the combination leading to a payout is not limited thereto but may be any combination of symbols as those provided in the table shown in FIG. 11. Moreover, although the symbol matrices are arranged in the form of a cross in this embodiment when the symbol matrices are cumulatively displayed on the upper display 33, this is just an example. It is possible to employ various forms of arrangements such as a stacking arrangement, a horizontal arrangement and an arrangement in which a symbol matrix taken up later should be displayed more largely.

As described above, the slot machine 10 includes the slot game areas A1 to A10 (10 at a maximum) in each of which a slot game can be individually played. By betting medals on two or more slot games in the respective slot game areas A1 to A10, the player can simultaneously play, in one play session, the two or more slot games in the slot game areas on which the medals are bet. In other words, a plurality of slot games can be played in one game machine. In this event, the slot games are executed respectively in the activated ones of the slot game areas A1 to A10 on the liquid crystal display 16. Thereafter, in the activated slot game areas, the symbol matrices in each of which at least one combination of symbols leading to a payout is established are cumulatively displayed on the upper display 33 that is the second display. When the number of the symbol matrices finally reaches an upper limit, a special effect image is displayed. Thus, it is possible to provide new entertainment properties that allow the player to have expectations for cumulative display of the symbol matrices on the upper display 33 and thereby can also allow the player to further focus on the slot game.

Note that, in the above example, credits are bet on at least one of the slot game areas A1 to A10 by inserting medals. However, credits may be bet by use of coins, bills, bar-coded tickets and the like other than the medals. Moreover, the description was given by taking, as an example, the case where, in each slot game, stopped symbols are scrolled and the symbols are subsequently stopped again. However, the slot game is not limited to the case of scrolling the symbols. For example, the slot machine according to the present invention may have a configuration in which the symbols displayed (arranged) in the respective display regions are individually changed and new symbols are displayed (rearranged). Furthermore, in the above example, the maximum number of credits that can be bet on the respective slot game areas A1 to A10 is set to 3. However, the present invention is not limited thereto.

The slot machine according to the embodiment of the present invention has been described above. However, the invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein. In this embodiment, one kind of character image, the frog character image X is used, for example, as the dynamic character image X that is the predetermined character image. However, several kinds of character images may be used as predetermined character images and simultaneously displayed. In such a case, in addition to setting of payouts in this embodiment, setting of payouts according to the kinds of the predetermined character images may be executed. Specifically, a payout amount may be set to vary according to the kinds of the predetermined character images.

Moreover, the effects described in the embodiment of the present invention are only a list of optimum effects achieved by the present invention. Hence, the effects of the present invention are not limited to those described in the embodiment of the present invention.

What is claimed is:

1. A slot machine comprising:
a first display adapted to display a plurality of symbol matrices including a plurality of symbols arranged in the symbol matrices;
a second display adapted to display a symbol matrix selected from the plurality of symbol matrices; and
a controller configured to
display a slot game on the first display, the slot game in which whether a credit is to be paid out or not is determined according to an arrangement determined by rearranging the plurality of symbols arranged in the symbol matrix, and
cumulatively display on the second display the symbol matrices each having an arrangement of the symbols for which a payout of a credit is determined as a result of the slot games executed in the respective symbol matrices displayed on the first display.

2. A slot machine comprising:
a first display adapted to display a plurality of symbol matrices including a plurality of symbols arranged in the symbol matrices;
a second display adapted to display a symbol matrix selected from the plurality of symbol matrices; and
a controller configured to
display a slot game on the first display, the slot game in which whether a credit is to be paid out or not is determined according to an arrangement determined by rearranging the plurality of symbols arranged in the symbol matrix,
cumulatively display on the second display the symbol matrices each having an arrangement of the symbols for which a payout of a credit is determined as a result of the slot games executed in the respective symbol matrices displayed on the first display, and
highlight the symbol matrices displayed on the second display more distinctly with an increase of a number of the symbol matrices displayed on the second display.

3. A slot machine comprising:
a first display adapted to display a plurality of symbol matrices including a plurality of symbols arranged in the symbol matrices;
a second display adapted to display a symbol matrix selected from the plurality of symbol matrices; and
a controller configured to
display a slot game on the first display, the slot game in which whether a credit is to be paid out or not is determined according to an arrangement determined by rearranging the plurality of symbols arranged in the symbol matrix,
cumulatively display on the second display the symbol matrices each having an arrangement of the symbols for which a payout of a credit is determined as a result of the slot games executed in the respective symbol matrices displayed on the first display,
highlight the symbol matrices displayed on the second display more distinctly with an increase of a number of the symbol matrices displayed on the second display, and
display a special effect image when the number of the symbol matrices displayed on the second display reaches a predetermined number.

4. The slot machine according to claim 1, wherein the controller is configured to reset the symbol matrices cumulatively displayed on the second display when all the slot games executable in the plurality of symbol matrices displayed on the first display are finished.

5. The slot machine according to claim 1, wherein the controller is configured to reset the symbol matrices cumulatively displayed on the second display when a number of the symbol matrices cumulatively displayed on the second display reaches a predetermined maximum value.

6. A method for controlling a slot machine, comprising the steps of:
executing a slot game, in each of a plurality of symbol matrices displayed on a first display, the slot game in which whether a credit is to be paid out or not is determined according to an arrangement determined by rearranging a plurality of symbols arranged in the symbol matrix; and
cumulatively displaying on a second display the symbol matrices each having an arrangement of the symbols for which a payout of a credit is determined as a result of the slot games executed in the respective symbol matrices displayed on the first display.

7. A method for controlling a slot machine, comprising the steps of:
executing a slot game, in each of a plurality of symbol matrices displayed on a first display, the slot game in which whether a credit is to be paid out or not is determined according to an arrangement determined by rearranging a plurality of symbols arranged in the symbol matrix;
cumulatively displaying on a second display the symbol matrices each having an arrangement of the symbols for which a payout of a credit is determined as a result of the slot games executed in the respective symbol matrices displayed on the first display; and
highlighting the symbol matrices displayed on the second display more distinctly with an increase of a number of the symbol matrices displayed on the second display.

8. A method for controlling a slot machine, comprising the steps of:
executing a slot game, in each of a plurality of symbol matrices displayed on a first display, the slot game in which whether a credit is to be paid out or not is determined according to an arrangement determined by rearranging a plurality of symbols arranged in the symbol matrix;
cumulatively displaying on a second display the symbol matrices each having an arrangement of the symbols for which a payout of a credit is determined as a result of the slot games executed in the respective symbol matrices displayed on the first display;
highlighting the symbol matrices displayed on the second display more distinctly with an increase of a number of the symbol matrices displayed on the second display; and
displaying a special effect image when the number of the symbol matrices displayed on the second display reaches a predetermined number.

9. The method for controlling a slot machine according to claim 6, the method further comprising the step of:
resetting the symbol matrices cumulatively displayed on the second display when all the slot games executable in the plurality of symbol matrices displayed on the first display are finished.

10. The method for controlling a slot machine according to claim 6, the method further comprising the step of:
resetting the symbol matrices cumulatively displayed on the second display when a number of the symbol matrices cumulatively displayed on the second display reaches a predetermined maximum value.
